(19) United States
(12) Patent Application Publication
(10) Pub. No.: US 2014/0114833 A1
(43) Pub. Date: Apr. 24, 2014

(54) Method to Reach Renewable Generation Policy Goals Through the Creation of a Renewable Generation Electricity Market

(71) Applicant: Aaron Rothschild, Ridgefield, CT (US)

(72) Inventor: Aaron Rothschild, Ridgefield, CT (US)

(21) Appl. No.: 14/059,772

(22) Filed: Oct. 22, 2013

Related U.S. Application Data
(60) Provisional application No. 61/717,015, filed on Oct. 22, 2012.

(51) Int. Cl. G06Q 40/04

(52) U.S. Cl. CPC G06Q 40/04
USPC 705/37

(57) ABSTRACT

A method of securing capital for use in utility and municipal services facilities, comprising: issuing a bond, wherein the bond comprise a contract for the future sale of utility services at fixed criteria and the utility service is sold to the bond issuer over a fixed time period, the time period having a future start date and future end date for which the utility service is supplied; then selling the bond to an investor, wherein the bond issuer receives funds from the sale of the bond; and transferring the bond via a financial market exchange.

### RELATED APPLICATIONS

This application is related to and claims the benefit of priority to U.S. Provisional Patent Application No. 61/717,015, entitled, “Method To Reach Renewable Generation Policy Goals Through The Creation Of A Renewable Generation Electricity Market” and filed Oct. 22, 2012, the contents of which are incorporated herein in there entirety.

### TECHNICAL FIELD

This invention relates to financial instruments, and more particularly to a securitized bond to facilitate delivery of renewable generation policy goals efficiency at the lowest cost to consumers.

### BACKGROUND

There is a growing effort in the U.S. to increase renewable energy production for a variety of policy goals. However, the parties involved in making policies can have conflicting goals. Legislators often consider local job growth the highest priority, while utility commissions have a mandate to provide energy at low-costs. Further, existing U.S. policy framework for subsidizing renewable energy projects is often complex and unpredictable. These factors create investor uncertainty and can ultimately lead to high, unpredictable consumer prices. To further develop renewable energy production in accordance with established policy goals, there exists a need to encourage capital investment into renewable energy production as a means of providing predictable, low-cost of energy to consumers.

### SUMMARY

A method is provided to secure capital for use in utility and municipal services facilities, the method comprising: issuing a bond, the bond comprising a contract for the future sale of utility services at a fixed criteria, wherein the utility service is sold to the bond issuer over a fixed time period, the time period having a future start date and future end date for which the utility service is supplied; selling the bonding to an investor, wherein the bond issuer receives funds from the sale of the bond; and transferring the bond via a financial market exchange.

In another implementation, a method is provided to secure capital for use in energy production facilities, comprising: issuing a bond, comprising a contract for the future sale of energy at fixed criteria, wherein energy is sold to the bond issuer over a fixed time period, the time period having a future start date and future end date for which the utility services is supplied; selling the bond to an investor, wherein the bond issuer receives funds from the sale of the bond; and transferring the bond via a financial market exchange.

These and other embodiments provide several advantages including: a transparent, open market and a framework for a robust investment market, leading to the development and maturity of alternative energy solutions.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 represents a long-term renewable contract that will guarantee the owner of the contracts a price per kWh for renewable electricity contributed to the grid.

FIG. 2 represents an example energy contract.

FIG. 3 represents energy pricing set by a regulator.

FIG. 4 represents energy pricing based on the market.

FIG. 5 represents energy pricing based on the market with long-term contracts.

FIG. 6 represents an example Renewable Generation Option Bond.

FIG. 7 represents an example of cash blow from a Renewable Generation Option Bond.

FIG. 8 represents energy pricing established by renewable generation bonds.

Like reference symbols in the various drawings indicate like elements.

### DETAILED DESCRIPTION

This disclosure provides an innovated market-based long-term renewable contract structure and delivery organization that will give State regulators the tools needed to deliver renewable generation policy goals effectively at the lowest cost to consumers.

The responsibility of the delivery organization will be, translating policy goals in auction process, resource planning, structuring contracts, obtaining credit rating and running trading platform.

The proposed Renewable Generation Electricity Market (“R-GEM”) is a collaborative trading company that works with State Governments to raise funds for renewable projects at the lowest possible cost to consumers. The trading platform gives policy makers and regulators the required tools to offer investors regulatory certainty with long-term market-based standardized contracts. The solution is offered on the State level, thus enabling control and flexibility while maintaining its structure as a liquid financial product. The proposed solution will drive innovation in the alternative energy industry.

R-GEM will offer four products that facilitate a transparent, open market while providing a framework for a robust alternative energy investment market leading to the development and maturity of alternative energy solutions in the US.
R-GEM Grid, a comprehensive energy grid and alternative energy site rating profile for each state
R-GEM Develop, the process by which funds are raised via securitized and standardized financial products. Securities are then sold to investors for alternative energy developments
R-GEM Trade, a platform to buy and sell R-GEM securities that have been issued
R-GEM Data, a comprehensive data service providing pricing, yield, default, rating and other valuable information on the security and state level

Criteria needed to develop a flourishing marketplace include open market policies, transparent and available data, and liquidity. R-GEM transforms a highly fragmented and opaque marketplace into a viable investment vehicle, thus transforming policy goals into actions by aligning the incentive structure of the consumer, policymaker, and investor. The combination of a standard investment vehicle that satisfies all stakeholder interests and data to evaluate and price potential investments lays the groundwork for a transparent and efficient marketplace to power the future.

The ideal type of auction would have to be determined. As a starting point the uniform-price auction format with a single-round, sealed-bid format should be put forth as the leading option, considering this is what was determined to be ideal in the Regional Greenhouse Gas Initiative (RGGI) auction analysis

### Contract Structure:

Each line of FIG. 1 represents a long-term renewable contract that will guarantee the owner of the contracts a price per kWh for renewable electricity contributed to the grid. The four contracts are auctioned on the same date in 2011, but have different prices and/or start dates.

Contracts are tradable credit rated bonds that allow institutional investors with limited energy industry expertise to understand, trust and trade.

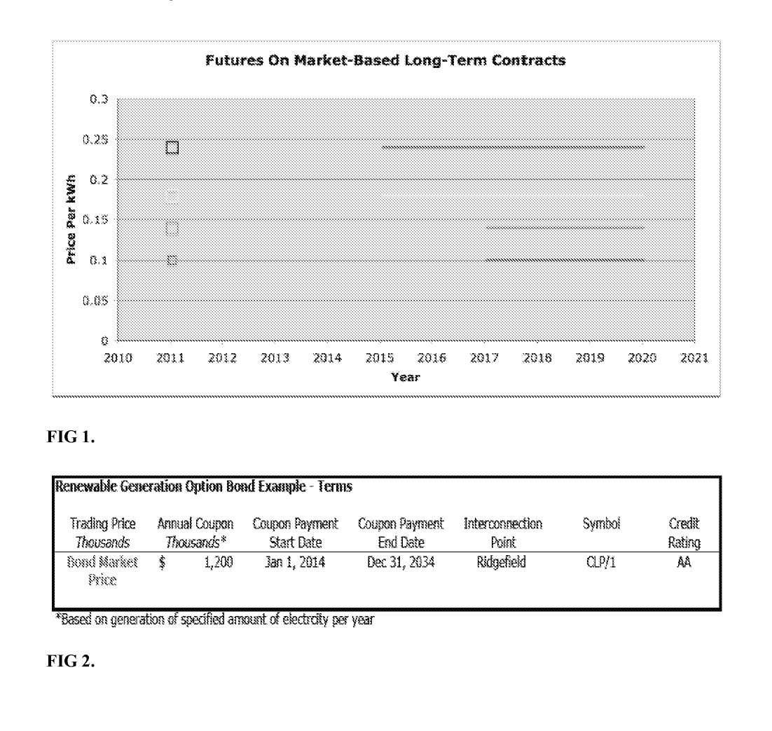

Contracts, such as the example shown in FIG. 2, can require specific generation technologies (solar, wind . . . ) and delivery point requirement (specific interconnection point, Connecticut Light & Power, State of Vermont or multi-state regions).

Performance obligation is no longer an issue for a generator who wins the bid by purchasing a contract because they would forfeit the high premium paid for the right to the earnings from generating the renewable electricity.

There is a growing effort in the U.S. to increase renewable energy production for a variety of policy goals. These include: protecting the environment, job growth and supporting emerging technologies. However, the parties involved in making policies can, and often do, have conflicting goals. Legislators often consider local job growth the highest priority while utility commissions have a mandate to provide energy at least-cost.

The question is: Once policy goals have been established and prioritized, what financial mechanisms and procurement processes can be used to attract investment and deliver energy to consumers as cheaply as possible in the short and long-term? This paper illustrates how a credit rated renewable generation bond could be used to raise the necessary funding while aligning the interests of consumers, investors and policy makers.

For 17 years officials from nearly 200 countries have gathered under the auspices of the United Nations to try and deal with climate change issues. The officials have left a trail of disillusion and discontent . . . . Who is qualified to tackle these tasks? They've been hoping to write a new, legally binding treaty covering all parties . . . . The agenda has narrowed and expectations have shrunk, yet the ship sails grimly on.
Others think that real progress will not emerge from any global forum but from action at the ground level by states and municipalities and private entities unencumbered by the United Nations climate process and its rules demanding consensus.

The stakes are high. In 2010, asset finance of new utility-scale renewable energy projects (wind farms, solar parks, bio-fuel and solar thermal plants), was $128 billion globally and $19.6 billion in The United States. Venture capital and private equity investment in renewable energy companies increased 19% over 2009, to $5.5 billion globally. After a rush to “catch” attractive subsidy deals before they expired in the fourth quarter of 2010, investment activity was subdued at the start of 2011. The biggest reductions in terms of absolute dollars came in U.S. wind power and European solar power.

At present, the complex and uncertain U.S. policy framework for subsidizing renewable energy projects is holding back investment and causing consumers to overpay. With no comprehensive Federal policy in place, thirty of the fifty states have moved forward on their own, setting statewide renewable generation goals.

Carbon taxes have no political support and cap and trade systems have already been implemented in certain states, but have yet to provide a way to increase carbon emission reduction standards to the level desired. The result is less than ideal and leaves certain inefficiencies.

Power Purchase Agreements (PPAs) and Feed-in Tariffs (FITs) provide the revenue certainty that drives investment to fund renewable generation projects. Both FITs and PPAs contractually obligate the utility company to connect the renewable energy generator usually at a fixed price per kWh—FITs apply broadly to a class of generators and PPAs are negotiated on a project by project basis. While both are often structured as long-term renewable contracts of 15 to 20 years which can spur investment—there are also costs and risks regarding the terms of the next round of long-term contracts.

Investors in renewable electric generation and transmission are also facing unpredictability in rates as set by the states. Add to that the different goals and agendas of state politicians, the varying characteristics of renewable generation and the performance of each technology in a wide range of locations and investor concerns only multiply exponentially.

All of this leads to a need for transparent, consistent and long-term policies for initiating and funding such renewable energy initiatives which benefit both consumers and investors while meeting state regulations.

Below we present the mechanisms by which funding can be implemented for renewable energy production, including pricing, volume and meeting interconnection needs.

### Long-Term Renewable Generation Contract Componets:

1. Price (per kWh)

2. Volume (Energy and Capacity)

3. Location (Interconnection point, State . . . )

### Price:

a. Regulator sets price

b. Market-Based—Ongoing

c. Market-Based—Long-Term Contract

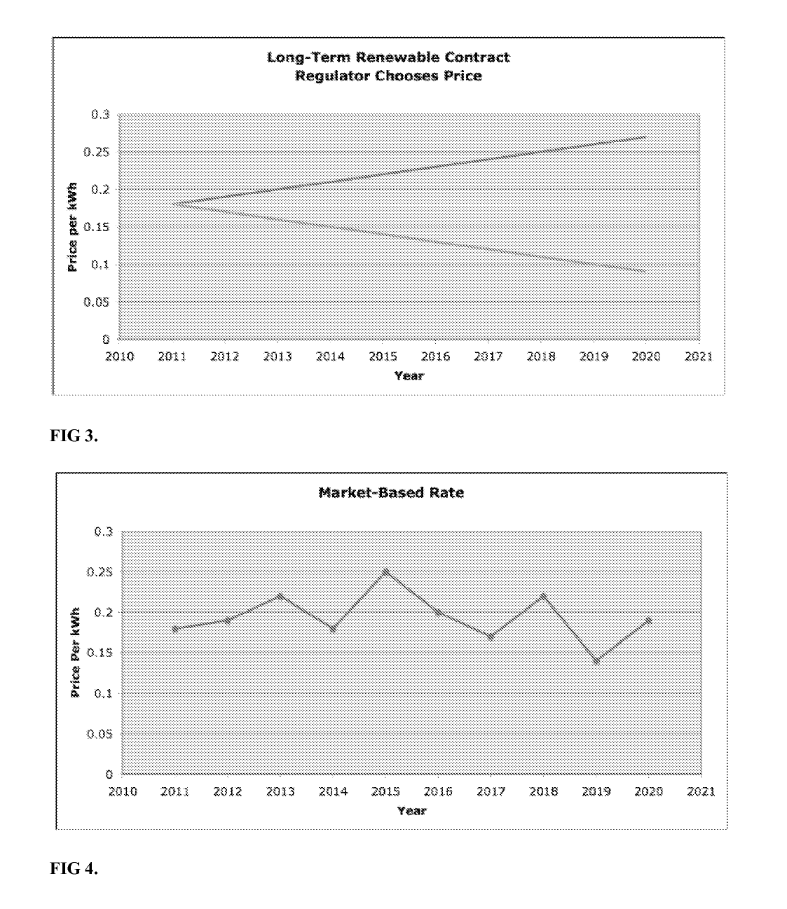

a. Regulator Sets Price
The regulator can determine a price per kWh for a certain period of time (FIG. 3) and contractors can then decide whether or not this will work for them and meet their needs. The problem that often ensues is that the price may not reflect the market. As a result, consumers may be asked to pay very high rates or providers may be asked to provide sufficient energy at a rate that is not cost effective.
b. Market-Based—Ongoing
The Market can determine the subsidized rate for renewable energy on an ongoing basis (FIG. 4). While this option is market based, investors do not have long-term price certainty. As a result, prices fluctuate dramatically, leaving customers and energy providers to deal with unpredictable rates. Example: SREC Market in New Jersey and other States in the North East.
c. Market-Based—Long-Term Contract
The market can determine prices for long-term contracts sold at auctions (FIG. 5). Option C can be viewed as best of both worlds. It allows the market to determine the price, keeping the cost low for consumers, while providing investors with long-term price certainty after purchasing a contract. The Renewable Auction Mechanism (RAM) that was started in California in November, 2011 is based on this contract structure.
d. Contract Structure
The market can determine prices for future long-term contracts sold at auctions. These future long term contracts can be made in the form of a state issued, securitized bond. This would allow a consumer to purchase a 20-year renewable energy bond based on the promise to provide renewable energy for the life of the bond. Securitized bonds sold through an SVP (Special Purpose Vehicle that secures the obligation of the bond) minimizes risk and typically receives high grades of AA or higher. As a result, the bond raises money for states to provide renewable energy which also serves as an attractive and marketable asset for investors.

### Example Bond Structure

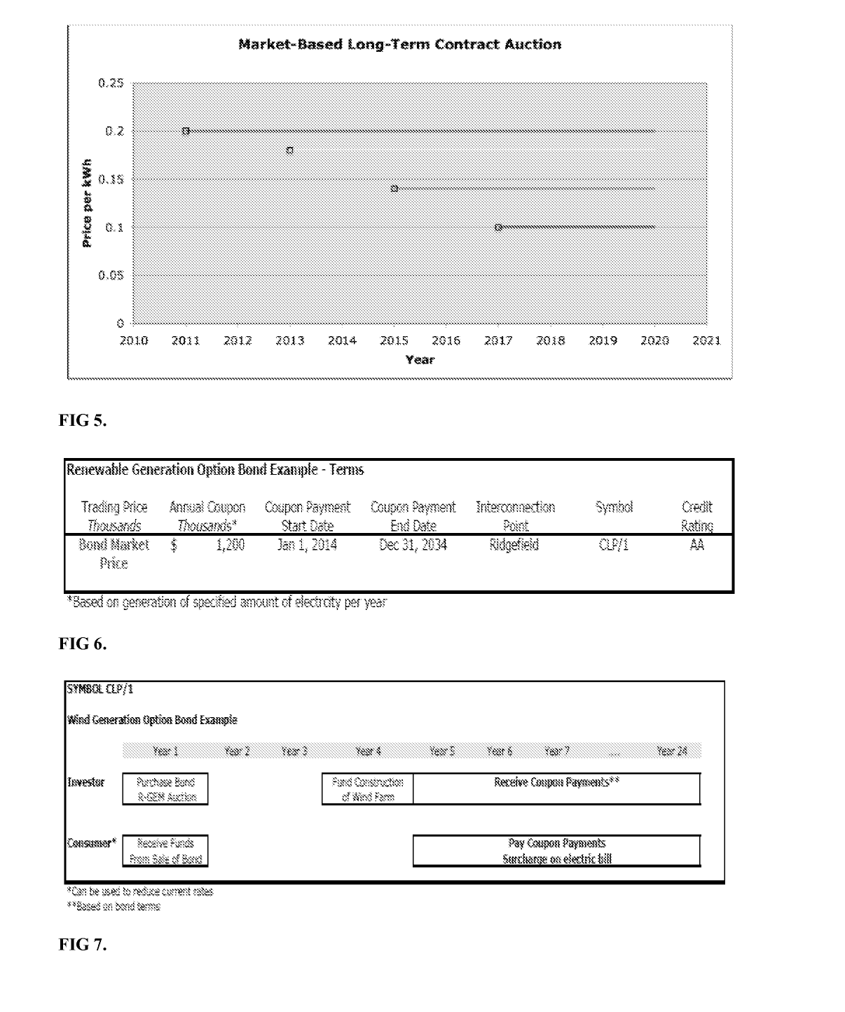

At the direction of policy makers, consumers' collectively sell Renewable Generation Option Bonds to investors. Example Contract for a wind farm in Connecticut is shown in FIG. 6.

### Cash Flows

1. Investor purchases bond (independent or utility company)

2. Consumers receive funds from bond sale to reduce current rates

3. Investor funds construction of generation facility

4. Investor receives coupon payments based on electricity generated from wind farm over 20-year term

5. Consumers pay coupon payments through surcharge on electric bill for 20-year term

6. Utility company is responsible for delivering power with an allowed rate of return

An example cash flow is illustrated in FIG. 7.

The flexibility by which bonds can be structured allows for each state to work with local policymakers and resource planning commissions to determine the specifics necessary from a cost and logistics standpoint. This would also allow regulators to determine which type of renewable energy (i.e. wind, solar, etc.) would be most effective and the size and scope of such projects prior to issuing the bonds.

### Volume:

Ways of managing volume:

a. Regulator chooses the price per kWh and developers receive contracts on a first come, first serve basis.

b. Regulator sets volume and developers are chosen based on least cost.

c. Regulator sets price, and market chooses volume. As a reserve price is established.

d. Regulator sets a price schedule and volume limit, and the market determines the actual volume.

### Our Choice

By utilizing option IV, regulators set a price schedule, but not a set price, and the volume limit is set by the market. This structure takes into account the ever changing technology in the renewable energy market. For example, the price of solar panels (and subsequently solar energy) has dropped sharply over the past two years. However, there is no certainty that the price will continue to decrease in the coming years and at what rate. As a result, the state could set it up so that developers could bid at auction on prices that are not commercially feasible today but may vary in the future. If technology does not advance to that point in the future, consumers would not lose anything. But if technology reaches the point at which developers are estimating that it will, they could implement the product. Such a mechanism would allow the market's price to reflect the probability of technological improvement which is important for driving innovation.

### Interconnection:

a. Each long-term renewable energy contract is tied to a specific location, and interconnection costs are included during auction process and approval.

b. The long-term renewable energy contract is not tied to a specific location, and interconnection costs are determined in the second round of negotiation or auction.

### Our Choice

Option B allows for a second auction, or even subsequent rounds of auctions, depending on the interconnectivity from the renewable energy facility, ultimately, to the consumer. Each state, through resource planning will need to determine the feasibility and costs necessary for such interconnections.

In this manner, a first auction would sell bonds for renewable energy, while the second auction, and potentially subsequent auctions, would sell rates based on the interconnectivity to one or more zone, region or state. Each bond price would be locked in. This would be ideal for states with the capacity to generate renewable energy to neighboring states at competitive rates. Investors could buy at auctions where they believe the price is affordable in specific areas and more attractive to consumers.

### Example:

### Price:

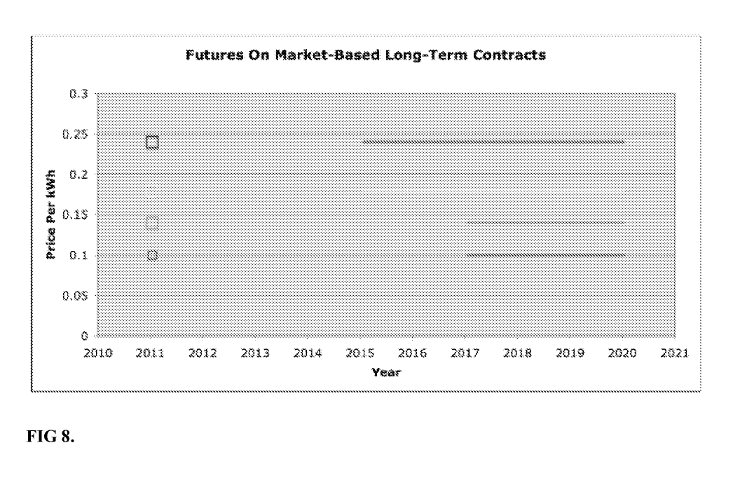

Renewable generation bonds are auctioned as bonds in advance, thus selling the rights to the contract that do not start for some time in the future, as illustrated in FIG. 8.

### Volume:

Regulator sets a price schedule and volume limit, and the market determines the actual volume.

### Interconnection:

The long-term renewable energy contract is not tied to a specific location, and interconnection costs are determined in the second round of negotiation or auction. Contracts are honored in multiple zones. (Zones can be geographical, utility-specific, and possibly inter-state.)

### Benefits:

Performance obligation is no longer an issue for developers of the generation facilities.

A market price is established for option to receive a long-term renewable contract with a subsidy level that is not yet profitable for existing technology.

### Issues:

Transmission infrastructure and available interconnection points may not be available when contract terms start. In the case of interconnection not being available, who is liable and what should the penalty be are issues that will need to be addressed.

Benefits to consumers must be communicated correctly. It is likely that cash flow management is more important than education, i.e. revenues received from sale of contracts should be given back to consumers at the time that the surcharge is added to consumers bills when the renewable generation is being contributed to the grid.

The technical feasibility of being able to provide contracts which are geographically flexible could prove very challenging.

A number of embodiments of the invention have been described. Nevertheless, it will be understood that various modifications may be made without departing from the spirit and scope of the invention. Accordingly, other embodiments are within the scope of the following claims.

What is claimed is:

1. A method of securing capital for use in utility and municipal services facilities, comprising:
issuing a bond, comprising:
a contract for the future sale of utility services at fixed criteria;
wherein the utility service is sold to the bond issuer over a fixed time period, the time period having a future start date and future end date for which the utility service is supplied;
selling the bond to an investor, wherein the bond issuer receives funds from the sale of the bond; and
transferring the bond via a financial market exchange.

2. The method of claim 1, wherein the utility and municipal services facilities comprise energy utilities, water utilities, telecommunications providers, television providers, or waste removal utilities.

3. The method of claim 1, wherein the funds received from the sale of the bond funds construction, improvement, or upkeep of the utility and municipal service facilities.

4. The method of claim 1, wherein the utility services comprise delivery of electricity, water, natural gas, television service, telecommunication service, or waste removal service.

5. The method of claim 1, wherein the fixed criteria comprise a sale price, a sale volume, a delivery location, or a combination thereof.

6. The method of claim 1, wherein the bond is securitized through the assignment and sale of the bond through a Special Purpose Vehicle (SPV).

7. The method of claim 1, wherein the bond is sold by the issuer through an auction.

8. The method of claim 7, wherein the auction is of a uniform price format or of a single-round sealed-bid format.

9. A method of securing capital for use in energy production facilities, comprising:
issuing a bond, comprising:
a contract for the future sale of energy at fixed criteria;
wherein energy is sold to the bond issuer over a fixed time period, the time period having a future start date and future end date for which the utility service is supplied;
selling the bond to an investor, wherein the bond issuer receives funds from the sale of the bond; and
transferring the bond via a financial market exchange.

10. The method of claim 9, wherein the funds received from the sale of the bond funds construction, improvement, or upkeep of energy production facilities.

11. The method of claim 9, wherein the energy production facilities produce energy from a renewable resource.

12. The method of claim 9, wherein the fixed criteria comprise a sale price, a sale volume, a delivery location, or a combination thereof.

13. The method of claim 9, wherein the bond is securitized through the assignment and sale of the bond through a Special Purpose Vehicle (SPV).

14. The method of claim 9, wherein the bond is sold by the issuer through an auction.

15. The method of claim 14, wherein the auction is of a uniform price format or of a single-round sealed-bid format.

16. The method of claim 11, wherein the renewable resource is solar radiation, wind, hydropower, or bio-fuel.

17. The method of claim 11, where the energy production facility is a wind farm, solar park, hydroelectric plant, solar thermal plant, or bio-fuel plant.
